(19) United States
(12) Patent Application Publication
(10) Pub. No.: US 2026/0191365 A1
(43) Pub. Date: Jul. 9, 2026

(54) Portable Picnic Organizer

(71) Applicant: Randal L. Cross, Redmond, OR (US)

(72) Inventor: Randal L. Cross, Redmond, OR (US)

(21) Appl. No.: 19/443,617

(22) Filed: Jan. 8, 2026

Related U.S. Application Data
(60) Provisional application No. 63/742,967, filed on Jan. 8, 2025.

(51) Int. Cl. A47J 47/16; A45C 11/20

(52) U.S. Cl. CPC A47J 47/16; A45C 11/20

(57) ABSTRACT

A portable rack which is configured to carry eating utensils and plates to a portable positioning at a picnic such as on a picnic table. A carrying handle is provided for carrying the assembled rack. The assembled rack has a first portable rack which may be coupled removably to a second portable rack. The rack has onboard compartments for the organized carrying of dishware, utensiles, and different condiments in a portable and organized configuration.

This application claims priority to U.S. Provisional Patent Application Ser. No. 63/742,967 filed on Jan. 8, 2025.

### BACKGROUND OF THE INVENTION

### 1. Field of the Invention

The invention herein disclosed relates generally to organizers for meals and the like. More particularly, it relates to a transportable organizer for carrying plates, eating utensils, and condiments, which has a pair of support stands which nest to allow for easy carrying, setup, and removal by a user.

### 2. Prior Art

### Background of the Invention

Picnics, such as meals at parks or camping on the beach, are often seen as a pleasant way to spend time outdoors. Such outings provide a chance to connect with nature while enjoying the sharing of a meal with friends or family.

However, despite their appeal, picnics are not without their problems. One common issue is dealing with transportation and packing of items needed for food serving and eating. Such can be cumbersome and disorganized, such as when plates and condiments and the like are packed within heavy baskets, especially when the number of participants could be considered to be that of a larger group.

Conventionally, when packing dishes and silverware for a picnic, it is generally important to focus on convenience for transport, use, and cleanliness. While generally picnickers try to use lightweight dishes and eating utensils and the like in an organized fashion, in many cases such items are just thrown in a bag or basket. Such can make the eventual picnic disorganized and less enjoyable.

With respect to the above, before explaining at least one preferred embodiment of the picnic organizer herein, it is to be understood that the disclosed device and method of employment thereof herein is not limited in its application to the details of employment and to any arrangement of steps set forth in the following description or illustrated in the drawings. The various apparatus components and configurations and methods of employment thereof as herein disclosed, are capable of other embodiments, and of being practiced and carried out in various ways, all of which will be obvious to those skilled in the art subsequent to their review of this specification.

Also, it is to be understood that the phraseology and terminology employed herein are for the purpose of description for an understanding of the picnic organizer system herein and should not be regarded as limiting. As such, those skilled in the art will appreciate that the conception upon which this disclosure is based may readily be utilized as a basis for other such organizers. It is important, therefore, that the embodiments, objects and claims herein, be regarded as including such equivalent construction and methodology insofar as they do not depart from the spirit and scope of the present invention.

### SUMMARY OF THE INVENTION

The picnic organizer device and method of employment thereof herein, provides for the easy and organized transport and usage of plates, eating utensils, and condiments for meals at parks, beaches, and other sites where outdoor meals are served. The device includes a first rack and a second rack wherein the second rack may be removably coupled to the first rack, for easy carrying, such as when both racks have onboard compartments that are fully stocked.

The first rack is configured for the storing and transport of multiple items used for serving and eating food at picnics, as well as meals outside. The first rack has a lower compartment projecting from a mount upon a first support member. The lower compartment is adapted to hold and provide a dispenser for dishes which are widely used for positioning and eating food thereon. The lower compartment is configured to hold any type of plate such as plastic or paper style plates, which are widely used for outdoor meals such as picnics.

Positioned on a front wall of the lower compartments may be a napkin compartment. The napkin compartment may be stocked with paper or other napkins which the users may take during their initial removal of a plate from the lower compartment.

An upper section of the first rack includes a plurality of secondary compartments which are adapted to hold and dispense silverware and eating utensils therefrom. Each secondary compartment, much like the lower compartment, has three sides forming a holding area and an open end from which the stored eating utensils project. This configuration allows users to easily view and grasp the desired eating utensils from the secondary compartment in which they are held and displayed.

The second rack is configured with a plurality of individual condiment compartments where each is engaged to and projects from a second support member. Each of the condiment compartments may be labeled as to a contents thereof, or because the polymeric material forming both the first rack and the second rack is preferably transparent, users may easily view the contents of each condiment compartment. By the term condiment compartment herein is meant any three sided open-ended compartment adapted to hold packaged condiments such as mustard, ketchup, sauces, salt, pepper, and other foodstuffs that users will conventionally add to, or atop, their chosen food. Of course depending on the type of food being served, the contents of the condiment compartments may change to thereby provide spices and sauces and the like which compliment the food being served.

The first support member extends from an engagement end thereof coupled to a first planar base to a distal end thereof. The second support member extends from an engagement end thereon coupled to a second planar base, to a second distal end of the second support member.

In one preferred mode, both the first support member and the second support member extend from their respective bases at an acute angle less than ninety degrees. This angles each of the first support member and the second support member rearward and at a slight downward angle toward the respective base to which they are engaged. Preferably the acute angle of each is between 40-80 degrees. This angled positioning is preferred because it renders both the first rack and the second rack much more stable when located on a support surface such as the ground or a table. Additionally, this rearward angle allows users looking downward on the first rack and the second rack, a better view of the contents of various compartments than if the racks were at perpendicular angles to their bases.

With respect to the above summary description, before explaining at least one preferred embodiment of the picnic organizer device and system herein, it is to be understood that the invention is not limited in its application to the details of operation nor the arrangement of the individual components or the steps set forth in the following description or illustrations in the drawings. The various methods of implementation and operation of the picnic organizer device and system and method herein, are capable of other embodiments and of being practiced and carried out in various ways which will be obvious to those skilled in the art upon their review of this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis by others for the designing of other modes for carrying out the several purposes of the present picnic organizer device and system. Therefore, the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Where used herein, if not otherwise defined, the term “substantially” means plus or minus five percent.

It is an object of this invention to provide an organizer for carrying eating utensils and condiments and the like which is portable.

It is a further object of this invention to provide such a portable organizer wherein two racks providing holders for the eating utensils and condiments and are stackable or nesting such that they may be carried as an engaged unit for easy transport.

It is a further object to provide such a portable organizer wherein the racks are formed of transparent material and configured to angle downward toward the support surface to thereby provide users, such as when viewing them from overhead, a better view of the contents of both racks.

These together with other objects and advantages, which become subsequently apparent, reside in the details of the construction and operation of the disclosed picnic organizer device and system herein as more fully hereinafter described and claimed, reference being had to the accompanying drawings forming a part thereof, wherein like numerals refer to like parts throughout.

Further objectives of this invention may be ascertained by those skilled in the art as brought out in the following part of the specification wherein detailed description is for the purpose of fully disclosing the invention without placing any limitations thereon.

### BRIEF DESCRIPTION OF DRAWING FIGURES

The accompanying drawings, which are incorporated herein and form a part of the specification, illustrate some but not the only or exclusive examples of embodiments and/or features of the disclosed picnic organizer system and device and method herein. It is intended that the embodiments and figures disclosed herein are to be considered illustrative of the invention herein, rather than limiting in any fashion.

In the drawings:

FIG. 1 shows a frontal view of a first portable rack which is configured to carry eating utensils and plates and showing a carrying handle extending therefrom.

FIG. 2 shows a frontal view of a second portable rack showing compartments thereon for the organized carrying of different condiments and showing three hooks which are employable to engage this second portable rack to the first portable rack for carrying.

FIG. 3 depicts a side view of both the first portable rack and the second portable rack moving toward and engagement thereof with the first portable rack using connectors such as the three hooks shown in FIG. 2.

FIG. 4 shows the engaged position of the second rack to the first rack wherein the connectors are engaged and the base of the second rack sits atop the base of the first rack and also shows the handle extending above the first rack.

FIG. 5 depicts an example of the device herein in a deployed configuration with the first rack atop one end of a table and the second rack atop an opposite end thereof and showing the rearward slant of the support members of each rack to provide stability.

Shown in FIG. 6 is a frontal view of the first rack situated on a support surface such as a table top and ready for use.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, first, second, and other such terms refer to the picnic organizer device herein and components thereof as they are oriented and appear in the drawings and all such terms are used for convenience only and such are not intended to be limiting or to imply that the picnic organizer device has to be used or positioned in any particular orientation.

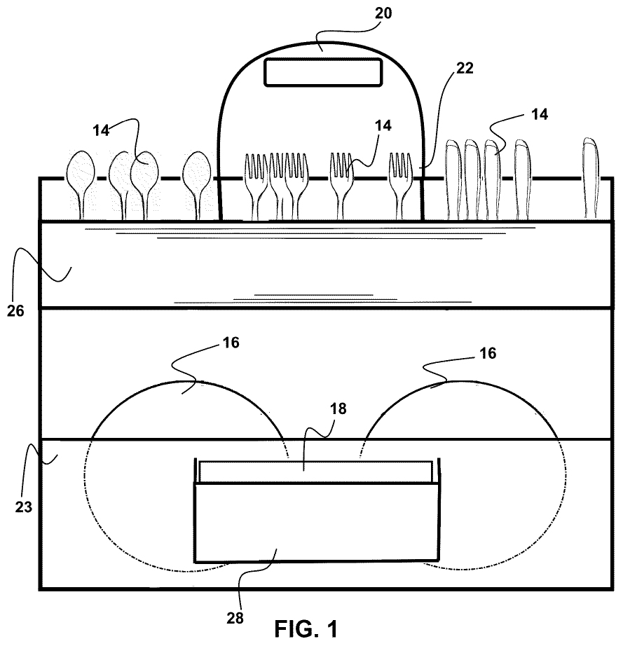

Now referring to drawings in FIGS. 1-6, there is seen, in FIG. 1 shows a frontal view of the first rack 12 which is configured to be portable and to carry eating utensils 14 and plates 12 and napkins 18. The body of the first rack 12 is preferably formed of transparent polymeric material and has a carrying handle 20 extending therefrom such as from or part of a first support member 22.

This first support member 22 provides a mount to hold a lower compartment 23 elevated above the first base 24 to which a first end of the first support member 22 is engaged. Also mounted to and extending from the first support member are secondary compartments 26 which are configured to hold the eating utensils 14. A napkin compartment 28 for dispensing napkins 18 may be engaged to a front wall of the lower compartment 23 holding the plates 16.

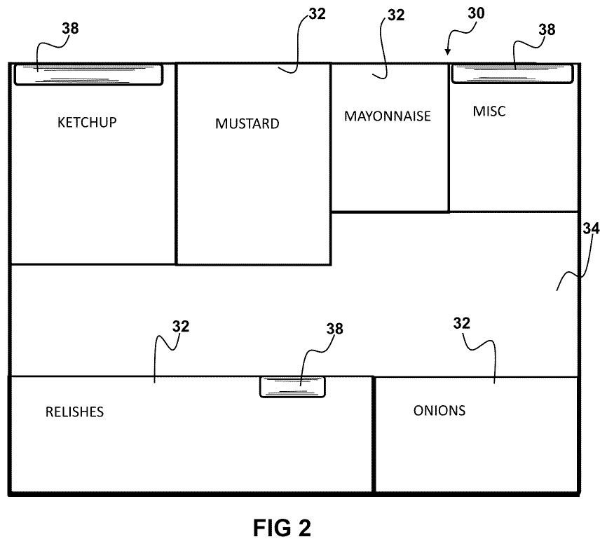

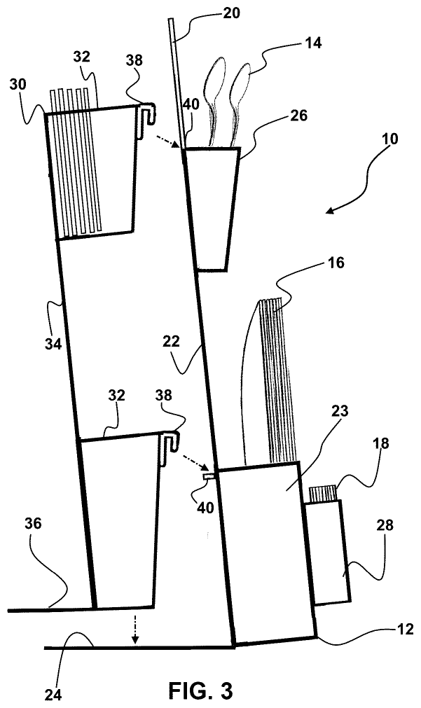

In FIG. 2 is depicted a frontal view of the second rack 20. As shown a plurality of condiment compartments 32 are engaged to and extend from a second support member 34 (FIG. 3) which is connected to the second base 36. Each of the condiment compartments 32 may be sized and configured to hold the desired condiments therein, and may be labeled for such.

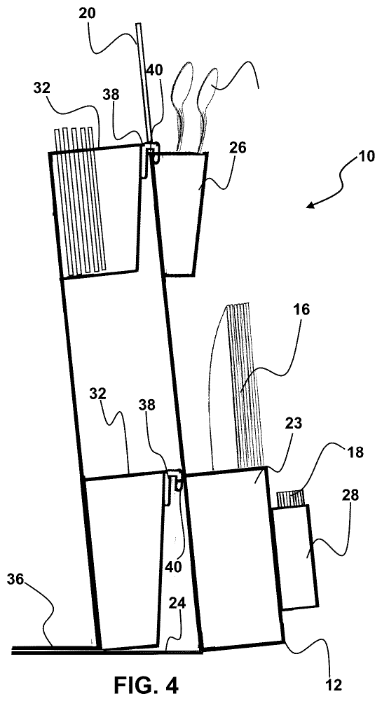

Shown in FIG. 3 is a side view of both the first portable rack device 10, shown in the disengaged position. As shown, the second rack 30 may be moved to an engaged position with the first rack 12 such as in FIG. 4, by removable coupling or connectors such as the three hooks 38 shown in FIG. 2 to mounts 40 located upon the first rack 12. Two upper connectors such as upper hooks 38 at the top edge of the second rack 30 couple over the top edge of the first rack 12 on opposite sides of the handle 20 extension. This over the top coupling is preferred to balance the load on opposing sides of the handle 20. A third of the connectros such as hooks 38 engages a hook mount 40 projecting from the rear side of the first support member 22.

With the connectors three hooks 38 so engaged such as shown in FIG. 4, the device 10 is in a carrying configuration wherein the second base 36 portion is situated and held atop the first base 24 of the first rack by the engaged hooks 38. The engaged or nesting configuration allows carrying of the assembled device 10 by the handle 20 during transport. Other connectors providing such a removable coupling may also be employed of course.

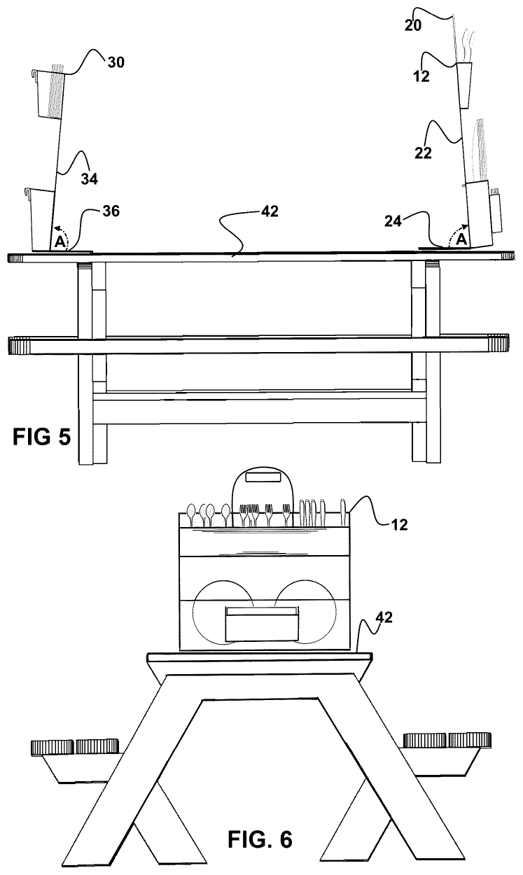

Use of the device 10 in a deployed configuration is shown in FIG. 5 wherein the first rack 12 is positioned with the first base 24 holding it elevated atop one end of a support surface such as a table 42. Also shown is the second rack 30 engaged to the second base 36 which is situated atop an opposite end of the table 42. Both the first support member 22 of the first rack 12 and the second support member 34 of the second rack 30 extend from the bases thereof at acute angles. This positions the front of both the first rack 12 and second rack 30 at an angle more easily viewed by a user looking down on them from above.

Shown in FIG. 6 is a depiction of a fully loaded first rack 12 in an as-used position atop a support surface such as a table 42. The transparent polymeric material forming the body of the first rack 12 and the second rack 30 allows users to easily view the contents of the various compartments during use.

While all of the fundamental characteristics and features of the disclosed portable picnic organizer device herein have been shown herein, with reference to particular embodiments thereof, a latitude of modification, various changes and substitutions are intended in the foregoing disclosure. It will be apparent that in some instances, some features of the picnic organizer device may be employed without a corresponding use of other features without departing from the scope of the invention as set forth.

It should also be understood that various substitutions, modifications, and equivalent variations may be made by those skilled in the art, upon viewing this disclosure without

departing from the spirit or scope of the invention. Consequently, all such modifications and variations and substitutions are considered included within the scope of the invention as defined by the following claims.

What is claimed is:

1. A portable picnic organizer apparatus, as shown and described herein.
